(19) United States
(12) Patent Application Publication
(10) Pub. No.: US 2014/0330627 A1
(43) Pub. Date: Nov. 6, 2014

(54) Payables Bidding System

(71) Applicant: Interstate Capital Corp., Santa Teresa, NM (US)

(72) Inventor: Tony Furman, El Paso, TX (US)

(73) Assignee: Interstate Capital Corp., Santa Teresa, NM (US)

(21) Appl. No.: 14/270,505

(22) Filed: May 6, 2014

Related U.S. Application Data
(60) Provisional application No. 61/819,936, filed on May 6, 2013.

(51) Int. Cl. G06Q 30/06; G06Q 30/02

(52) U.S. Cl. CPC G06Q 30/0611; G06Q 30/0222
USPC 705/14.23; 705/26.4

(57) ABSTRACT

A buyer-centric payables bidding method, system, and computer-implemented program instructions are disclosed. The payables bidding system facilitates the discounting of vouchered payables through an online bid process. In the online auction process, suppliers of goods and/or services bid on the right to collect vouchered payments from buyer before the previously agreed “due date” of those payments. The online bid is defined as the discounted amount a supplier is willing to accept in exchange for obtaining prompt payment on a vouchered payment.

### CROSS REFERENCE TO RELATED APPLICATIONS

This application claims the priority and benefit under 35 U.S.C. §119(e) of U.S. Provisional Patent Application Ser. No. 61/819,936 filed on May 6, 2013, and entitled “PAYABLES BIDDING SYSTEM,” the entirely of which is incorporated herein by reference.

### FIELD OF THE INVENTION

The disclosed embodiments relate to a payables auction. The disclosed embodiments further relate to a buyer-centric payables auction system and method. The disclosed embodiments also relate to buyers and suppliers participating in an online auction for buyers' payables.

### BACKGROUND

In the traditional sales model, buyers and suppliers negotiate three items at the beginning of the sales cycle before the delivery of goods or services: 1) the cost of goods or services; 2) the payment terms: and 3) prompt payment discounts, if any. The latter two items are often imposed upon the supplier by the buyer. Payment terms describe how much time the buyer is given to pay for goods or services once delivered by the supplier. Typical payment terms are “Net 30”, “Net 60”, or “Net 90” meaning that full payment is due to the supplier from the buyer in 30, 60, or 90 days, respectively, from the date of delivery by the supplier. There are myriads of less common payment term variations. A prompt-payment discount is defined as the negotiated discount by which a buyer may discount its payment to the supplier if paid promptly, generally by a specified number of days after submission of the invoice to the buyer (i.e., before the negotiated payment term dictates).

The longer the payment terms, the longer the supplier has to wait for payment, and the more likely it is to experience cash flow strain or be receptive to the offer of a prompt-payment discount. On the other hand, longer payment terms are generally favorable for the buyer, which gets to hold on to its cash for a longer time period before paying suppliers. To assist suppliers, purchasing agents often offer suppliers the right to obtain payment before the agreed terms in exchange for a pre-determined, negotiated or dictated “prompt-payment discount.”

Challenges exist in the traditional model of negotiation of prompt-payment discounts. By design, prompt-payment discounts offered by buyers favor the buyer, in the sense that prepaying suppliers in exchange for an explicit discount generally produces a greater return on the buyer's investment than its cost of funds. Nonetheless, the offering or negotiating of prompt-payment discounts is an inexact, inefficient, and costly process that falls short of finding the maximum amount by which suppliers' will discount their receivables in exchange for prepayment and increases buyer's cost of goods sold.

Larger buyers have a general negotiating advantage over smaller suppliers. Buyers traditionally depend on financing provided by their suppliers as a primary source of working capital—in the sense that buyers do not immediately pay for goods and services upon delivery by the supplier—they wait to pay their suppliers in accordance with the negotiated payment terms. Such trade financing is a major and growing source of financing for buyers.

Another limitation in the traditional sales model is the extent to which buyers can negotiate extended payment terms. The extent to which extended payment terms can be negotiated is often subject to two primary limiting forces: 1) suppliers' ability to finance buyers; and 2) the extent to which suppliers will increase pricing to offset the cost of financing their buyers. The longer the supplier is required to finance its buyer, the higher its costs of financing will be, and the more likely the supplier is to build that cost into its pricing of its goods or services. Yet another limiting factor for suppliers in the traditional sales model is suppliers' dependence on external financing sources. Suppliers traditionally count on external financing sources such as banks, asset-based lenders, and factoring companies to provide suppliers with financing necessary for them to further provide credit terms to their buyers/customers. Suppliers' cost of borrowed funds is significantly higher than their buyers in most cases.

One-size-fits-all supplier financing models fail to opportunize in differences on financing demands for supplier. As a management or purchasing policy, prompt-payment discounts are offered by buyers to select suppliers, relating to all transactions, or are offered across-the-board to all suppliers without regard to 1) how large a discount the supplier may actually accept; 2) the financing needs of the supplier; or 3) other unknown variables, any or all of which may affect how significant a discount the supplier might be willing to accept. For example, a buyer may be able to demand a steeper discount from a supplier whose cost of borrowed funds is very high. As another example, a buyer may be able to demand a steeper discount from a supplier on transactions where the supplier's profit margin is very high. The absence of critical information places the buyer at a disadvantage in the negotiation of prompt-payment discounts. Negotiation of prompt-payment discounts on a transaction by transaction basis would be a time-consuming proposition, the cost of which might very well outweigh the benefit.

Buyer usually does not know what a supplier's need for prompt payment might be. The buyer, as previously stated, is at a distinct disadvantage, whether discussing, offering, or negotiating prompt payment discounts with its suppliers at any stage of the transaction, because the supplier will not willingly reveal the critical variables that might affect how much discount the supplier might ultimately be willing to accept on any given transaction. Further, the buyer is seldom familiar with suppliers' overall financial picture which may change from time to time. The supplier's financial condition is also a likely variable that will drive suppliers' demand for prompt-payment discounts. It is a certainty that, when negotiating a sale with a large customer, a supplier will not disclose financial distress. It is not therefore unreasonable to assume, that the discount amount that a given supplier may be willing to accept on any given transaction may vary significantly from transaction to transaction, and from supplier to supplier, depending on numerous known or unknown variables. Since prompt-payment discounts tend to be generally offered by buyers to suppliers across the board the discount is the same for each and every supplier and for each and every transaction with any given supplier), the buyer invariably leaves money on the table.

Buyers that impose lengthy payment terms run the risk of having to pay more for goods and services because suppliers tend to bury the cost of financing in their pricing of goods and services. When a supplier knows in advance of the prompt-payment discount offered by a given buyer, the supplier will tend to build the cost of the discount into their price to the buyer, adversely affecting the buyer's gross margins.

Therefore, a need exists for a buyer-centric payables bidding method and system.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is therefore an object of the disclosed embodiments to a payables auction.

It is another object of the disclosed embodiments to a buyer-centric payables auction system and method.

It is an object of the disclosed embodiments for buyers and suppliers to actively participate and communicate in an online auction for buyers' payables.

The above and other aspects can be achieved as is now described. A buyer-centric payables bidding method, system, and computer-implemented program instructions are disclosed. The payables bidding system facilitates the discounting of vouchered payables through an online bid process. In the online auction process, suppliers of goods and/or services bid on the right to collect vouchered payments from buyer before the previously agreed “due date” of those payments. The online bid is defined as the discounted amount a supplier is willing to accept in exchange for obtaining prompt payment on a vouchered payment. An exemplary Vouchered Payment as used herein is defined as a Payment which has been absolutely approved and authorized for payment by Client, or a plurality of payments approved and authorized for payment by Client, relating to goods or services satisfactorily delivered by any Supplier, or plurality of Suppliers, wherein said vouchered payment is unconditionally approved and authorized for payment by Client, but not yet “due” for payment at the current date.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates an exemplary block diagram of an exemplary data-processing apparatus, which can be utilized for processing secure data, in accordance with the disclosed embodiments;

FIG. 2 illustrates an exemplary schematic view of an exemplary software system including an operating system, application software, and a user interface, in accordance with the disclosed embodiments;

FIG. 3 illustrates an exemplary flow chart of operations depicting logical operational steps of a payables bidding system, as disclosed in an embodiment; and

FIG. 4 illustrates an exemplary flow chart of operations depicting logical operational steps of multiple bids in a payables bidding system, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (Including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The disclosed embodiments describe a buyer-centric payables bidding method, system, and computer-implemented program instructions. The disclosed embodiments facilitate the discounting of vouchered payables through an online bid process wherein suppliers of goods and/or services bid on the right to collect vouchered payments from buyers before the previously agreed “due date” of those payments. The online bid can be defined as the discounted amount, the percentage discount, the dollar amount of the discount, or the percentage of the amount of the discount a supplier is willing to accept in exchange for obtaining prompt payment on a vouchered payment. The bid can be expressed as a percentage of an amount of payment vouchered payable. Buyers essentially put out to bid to their respective suppliers to participate in an online auction for opportunity to obtain immediate payment on a vouchered payable.

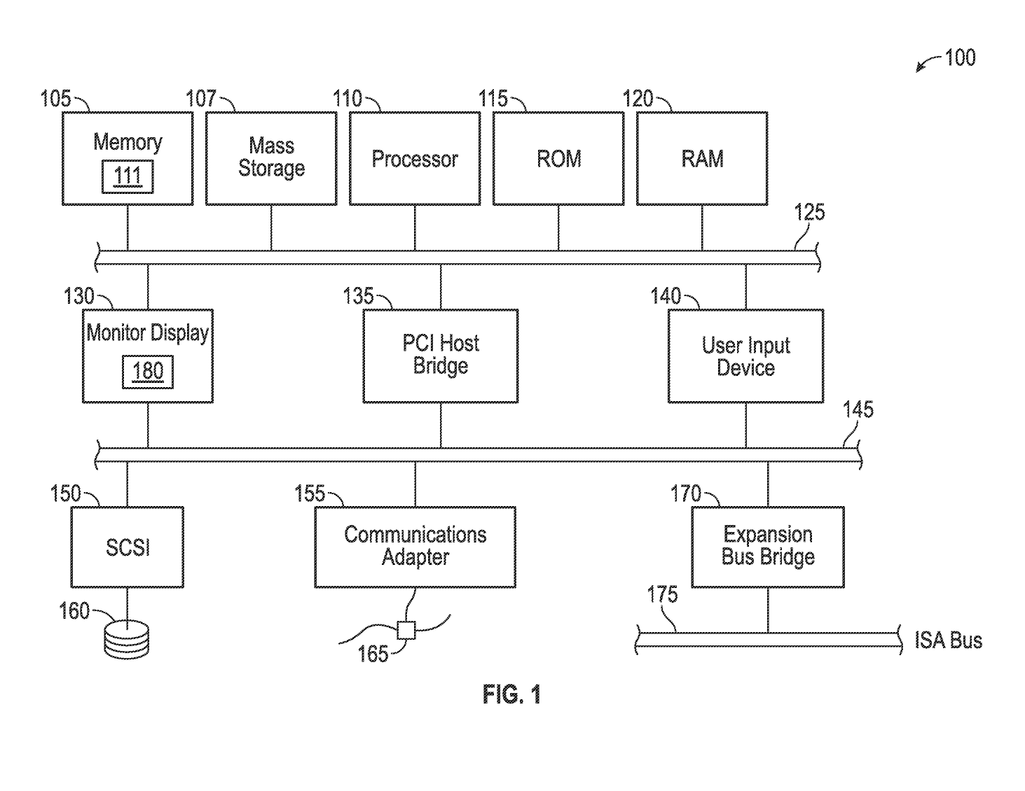

FIG. 1 illustrates a block diagram of a sample data-processing apparatus 100, which can be utilized for an improved payables bidding system and method. Data-processing apparatus 100 represents one of many possible data-processing and/or computing devices, which can be utilized in accordance with the disclosed embodiments. It can be appreciated that data-processing apparatus 100 and its components are presented for generally illustrative purposes only and do not constitute limiting features of the disclosed embodiments.

As depicted in FIG. 1, a memory 105, a mass storage 107 (e.g., hard disk), a processor (CPU) 110, a Read-Only Memory (ROM) 115, and a Random-Access Memory (RAM) 120 are generally connected to a system bus 125 of data-processing apparatus 100. Memory 105 can be implemented as a ROM, RAM, a combination thereof, or simply a general memory unit. Module 111 includes software module in the form of routines and/or subroutines for carrying out features of the present invention and can be additionally stored within memory 105 and then retrieved and processed via processor 110 to perform a particular task. A user input device 140, such as a keyboard, mouse, or another pointing device, can be connected to PCI (Peripheral Component Interconnect) bus 145.

Data-process apparatus 100 can thus include CPU 110, ROM 115, and RAM 120, which are also coupled to a PCI (Peripheral Component Interconnect) local bus 145 of data-processing apparatus 100 through PCI Host Bridge 135. The PCI Host Bridge 135 can provide a low latency path through which processor 110 may directly access PCI devices mapped anywhere within bus memory and/or input/output (I/O) address spaces. PCI Host Bridge 135 can also provide a high bandwidth path for allowing PCI devices to directly access RAM 120.

A communications adapter 155, a small computer system interface (SCSI) 150, and an expansion bus-bridge 170 can also be attached to PCI local bus 145. The communications adapter 155 can be utilized for connecting data-processing apparatus 100 to a network 165. SCSI 150 can be utilized to control high-speed SCSI disk drive 160. An expansion bus-bridge 170, such as a PCI-to-ISA bus bridge, may be utilized for coupling ISA bus 175 to PCI local bus 145. Note that PCI local bus 145 can further be connected to a monitor 130, which functions as a display (e.g., a video monitor) for displaying data and information for a user and also for interactively displaying a graphical user interface (GUI) 180. A user actuates the appropriate keys on the GUI 180 to select data file options. Note that the term “GUI” generally refers to a type of environment that represents programs, files, options, and so forth by means of graphically displayed icons, menus, and dialog boxes on a computer monitor screen.

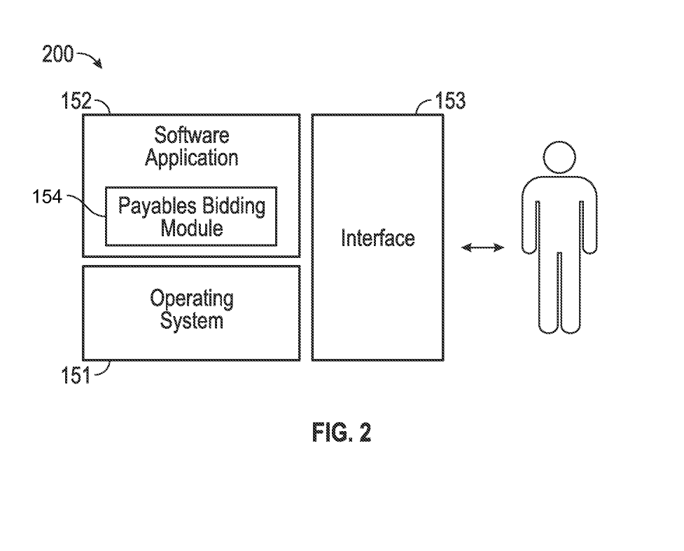

The embodiments described herein can be implemented in the context of a host operating system and one or more modules. Such modules may constitute hardware modules, such as, for example, electronic components of a computer system. Such modules may also constitute software modules. In the computer programming arts, a software “module” can be typically implemented as a collection of routines and data structures that performs particular tasks or implements a particular abstract data type. Software modules generally can include instruction media storable within a memory location of an image processing apparatus and are typically composed of two parts. First, a software module may list the constants, data types, variable, routines, and the like that can be accessed by other modules or routines. Second, a software module can be configured as an implementation, which can be private (i.e., accessible perhaps only to the module), and that contains the source code that actually implements the routines or subroutines upon which the module is based. The term “module” as utilized herein can therefore generally refer to software modules or implementations thereof. Such modules can be utilized separately or together to form a program product that can be implemented through signal-bearing media, including transmission media and/or recordable media. An example of such a module that can embody features of the present invention is a payables bidding module 154, as depicted in FIG. 2.

It is important to note that, although the embodiments are described in the context of a fully functional data-processing system (e.g., a computer system), those skilled in the art will appreciate that the mechanisms of the embodiments are capable of being distributed as a non-transitory, computer-usable or computer-readable program product in a variety of forms, and that the present invention applies equally regardless of the particular type of signal-bearing media utilized to actually carry out the distribution. Examples of signal bearing media include, but are not limited to, recordable-type media such as media storage or CD-ROMs and transmission-type media such as analogue or digital communications links.

FIG. 2 illustrates a schematic view of a software system 200 including an operating system, application software, and a user interface for carrying out the disclosed embodiments. Computer software system 200 directs the operation of the data-processing system 100 depicted in FIG. 1. Software application 152, stored in main memory 105 and on mass storage 107, includes a kernel or operating system 151 and a shell or interface 153. Software application 152 comprises a payables bidding module 154. One or more application programs, such as software application 152, may be “loaded” (i.e., transferred from mass storage 107 into the main memory 105) for execution by the data-processing system 100. The data-processing system 100 receives user commands and data through the interface 153, as shown in FIG. 2. The user's command input may then be acted upon by the data-processing system 100 in accordance with instructions from operating module 151 and/or application module 152.

The interface 153 also serves to facilitate payables bidding, whereupon the user may supply additional inputs or terminate the session. In an embodiment, operating system 151 and interface 153 can be implemented in the context of a “Windows” system. It can be appreciated, of course, that other types of systems are possible. For example, rather than a traditional “Windows” system, other operation systems such as, for example, Linux may also be employed with respect to operating system 151 and interface 153. The software application 152 can include a payables bidding module 154. The software application 152 can also be configured to communicate with the interface 153 and various components and other modules and features as described herein.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program design to assist in the performance of a specific task, such as word processing, accounting, inventory management, music program scheduling, etc.

Generally, program modules include routines, programs, objects, components, data structures, etc., that perform particular tasks or implement particular abstract data types. Moreover, those skilled in the art will appreciate that the disclosed method and system may be practiced with other computer system configurations, such as, for example, hand-held devices, multi-processor systems, microprocessor-based or programmable consumer electronics, networked PCs, minicomputers, mainframe computers, and the like.

The disclosed embodiments of the Payables Bidding System, method, and computer program instructions allow buyers to maximize discounts offered by suppliers on the buyers payables by; 1) eliminating the practice of offering static prompt-payment discounts; 2) pushing out through electronic communication vouchered payables out to bid to suppliers; 3) creating an online auction or bidding system or environment; and 4) a decision matrix and/or algorithm to accept or reject bids.

Credit-constrained suppliers may be unable to obtain external financing for any number of reasons. Ultimately, the disclosed Payables Bidding System represents an improvement over the traditional supply chain finance model by allowing suppliers to tap the value of their unpaid receivables directly with the buyer, and eliminating or reducing the need for traditional modes of external receivable financing such as bank borrowings and factoring. A further improvement includes shifting the traditional pre-transaction prompt payment discount negotiation to a post-transaction bid system, when the supplier is more likely to accept a larger discount. Moreover, Payables Bidding System allows for the financing of receivables in industries and market niches where receivable financing was previously not plausible or prohibitively expensive. Similarly, Payables Bidding System provides a credit alternative in foreign markets wherein credit markets may be unreliable, expensive, or not fully developed.

Payables Bidding System comprises a web-based or cloud-based portal where buyers (e.g., companies, large companies, governmental agencies, public bodies, or individuals with payment obligations) post their vouchered payments and suppliers are able to bid on and obtain prompt payments at a discount. Payables Bidding System represents a paradigm shift in the multi-trillion dollar supply chain industry, long dominated by banks, asset-based lenders, and factoring companies, by giving buyers the ability to allow their suppliers to bid an acceptable “discount rate”. In exchange, the supplier gains the right to receive payment promptly, such as, for example, before the “due date” established by the buyer. For suppliers that need the occasional ability to obtain immediate payment from their customers, Payables Bidding System is the perfect flexible and affordable liquidity solution. There are no applications to complete, no fees, no contracts, no limits, no minimums, and no set up costs in Payables Bidding System.

Benefits of the disclosed embodiments are numerous. The disclosed embodiments provide suppliers with an alternative to waiting for payments from buyers, along with an alternative to external funding. Further, suppliers are allowed access to additional capital without disturbing existing external funding sources (i.e., banks, asset-based lenders, and factoring companies). Buyers' pricing, payment terms, and negotiating leverage improve by providing suppliers a viable alternative to waiting for payment or reliance upon external financing. The disclosed embodiments automate the process of soliciting discounts from suppliers, creating efficiencies for the buyer during the purchasing process. Buyers therefore maximize discounts on every transaction. Buyer-supplier relationship is strengthened by giving suppliers peace-of-mind. In the event of a liquidity shortfall, supplier may convert their receivable to instant cash without the need for external financing.

It is understood that an exemplary “Buyer” as used herein represents the disclosed Payables Bidding System's “Client.” An exemplary Buyer is defined as a company, a plurality of companies, a large company with various annual revenues, for example, a governmental agency, public body, or an individual with payables or payment obligations. It is further understood that a client is not limited solely to a large company, but can comprise any size company or governmental or public body with vouchered payables or payment obligations.

An exemplary “Supplier” or “Vendor” is defined herein as a company, small company or a plurality of small companies, government agency, public body, or individual that sells goods and/or services to Buyers.

As used herein, an exemplary “Bid” is defined as the discount a Supplier is willing to accept in exchange for obtaining prompt payment on vouchered payments, wherein said Bid is expressed as a percentage discount of an amount of a vouchered payment expressed as either in dollars or percentage discount, for example.

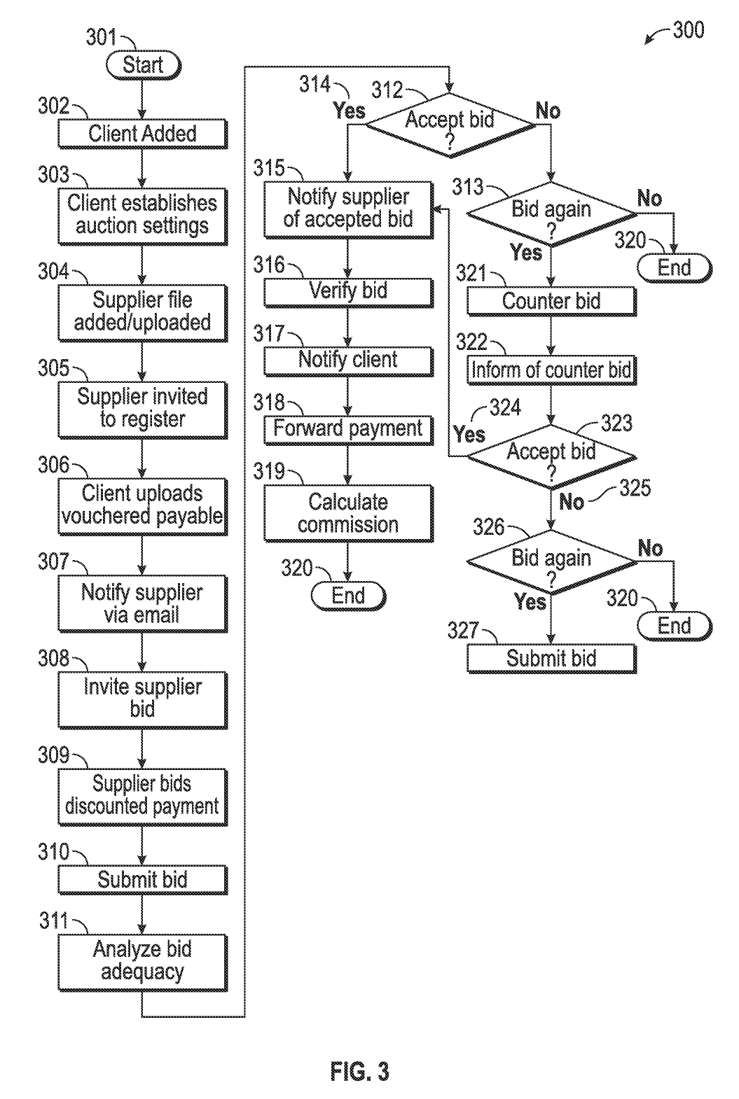

FIG. 3 illustrates an exemplary flow chart 300 depicting logical operational steps of a payables bidding system, as disclosed in an embodiment. The following exemplary scenario is intended to illustrate functionality of the disclosed Payables Bidding System and is not intended to limit the Payables Bidding System in any manner. The particular values and configurations discussed in these non-limiting examples can be varied and are cited merely to illustrate at least one embodiment and are not intended to limit the scope thereof.

As illustrated in block 301, the process for bidding on payables can be initiated. In other embodiments, the system involves suppliers bidding against other suppliers for a limited amount of payments. An individual auction can comprise groups of vouchered payables with a common or like due date or random due dates.

Next, as illustrated in block 302, a Client (i.e., Buyer) is added to the Payables Bidding System. Client then establishes auction settings, as illustrated in block 303. The disclosed embodiments automatically inform suppliers of the availability to receive payment on approved but unpaid invoices thru electronic means, the length of time of each auction, and frequency of bidding. A GUI, an online “control panel” GUI, or other interface can be provided in embodiments, from which the buyer, supplier, and Payables Bidding System administrators may view information, apply filters to data, sort data, import data, export data, edit data, enter data, delete data, approve data, view predictive models, view and modify any and all information pertaining to bids, auctions, buyers, suppliers, access comprehensive reporting that includes, among other things; averages, metrics, bid histories, acceptance histories, suppliers, payments, bidding patterns, and payment methods. In an embodiment, the payables bidding system contains “field selector” technology.”

Next, as illustrated in block 304, the Supplier information is added, uploaded to, or acquired by Payables Bidding System. This information includes supplier contact info, identifying information, authorized supplier parties, and other similar information. Jewelry Supplier sold jewelry (e.g., bracelets) to Buyer for $5,000 on payment terms of Net 60 days. Buyer's payment to Jewelry Supplier is therefore due 60 days from the date of delivery of the bracelets to Buyer. Buyer requires 14 days to inspect the bracelets and approve and authorize the $5,000 payment to be made to Jewelry Supplier 46 days later, for example.

As illustrated in block 305, a Supplier is invited to register with the Payables Bidding System. As illustrated in block 306, Buyer uploads a vouchered payable. Jewelry Supplier sold jewelry (e.g., bracelets) to Buyer for $5,000 on payment terms of Net 60 days. Buyer's payment to Jewelry Supplier is therefore due 60 days from the date of delivery of the bracelets to Buyer. Buyer requires 14 days to inspect the bracelets and approve and authorize the $5,000 payment to be made to Jewelry Supplier 46 days later, for example. In this case, a file is uploaded containing Jewelry Supplier's $5,000 vouchered payment to Payables Bidding System website. It is understood that the Payables Bidding System can obtain vouchered payables information in any variety of methods. In some embodiments, the buyer uploads its vouchered payables to a website for real-Lime or delayed auction/bidding updates to clients, suppliers, and Payables Bidding System. Next in block 307, Payables Bidding System notifies Jewelry Supplier of vouchered payables which may be bid upon and provides an invitation to register with the System, if not previously registered. As illustrated in block 308, Payables Bidding System invites Jewelry Supplier to bid for the right to receive payment promptly at the end of the auction rather than having to wait for payment. In block 309, Jewelry Supplier may enter a bid through the Payables Bidding System website to obtain prompt payment (at a discount) on the vouchered payable at the end of the auction.

As illustrated in block 310, Jewelry Supplier's Bid is submitted via the GUI in the disclosed Payables Bidding System. Jewelry Supplier bids $4,900, for example, as the amount it is willing to accept as full satisfaction of the Buyer's $5,000 payment obligation, contingent upon the Buyer's prompt payment. The $4,900 represents a $100 discount from the $5,000 jewelry invoice, or a 2% discount off Jewelry Supplier's invoice.

Payables Bidding System through its auction concept essentially forces Jewelry Supplier to “self-price discriminate,” allowing Payables Bidding System to limit “consumer surplus” by finding or getting relatively closer to the true price the Jewelry Supplier is willing to pay for the receivable financing which maximizes discounts for the Buyer. Payables Bidding System promotes constant contact between Buyer and Jewelry Supplier using electronic means to increase the likelihood of Jewelry Supplier offering an acceptable prompt payment discount.

As illustrated in block 311, system analyzes acceptable bid ranges for at least one of possible acceptance, possible rejection, delayed acceptance, delayed rejection, automatic acceptance, or automatic rejection of Jewelry Supplier's bid. For example, Payables Bidding System is automatically configured to reject Jewelry Supplier's bid greater than $4,900 and automatically accept Jewelry Supplier's bid equal to or less than 4,900. The system allows the buyer to limit its investment on an auction-by-auction basis. A system that contains a feature that limits the approval of any given suppliers bids by a certain amount or percentage of total payments in any given auction, or over any given time period.

As illustrated in block 312, Payables Bidding System either accepts or rejects Jewelry Supplier's $4,900 bid. The bids in certain auctions as provided in embodiments may be immediately accepted or rejected. Buyer can configure Payables Bidding System to accept bids at a certain price and/or percentage discount. Suppliers may or may not be informed about bid acceptance or rejection until the close of auction. Payables Bidding System uses logic and reasoning to accept or reject supplier's bid of $4,900 based on preferences established by Buyer in GUI and a decision matrix developed by Payables Bidding System. An algorithm could be implemented in the disclosed embodiments that use dynamic logic that determines bid suitability, taking into account criteria established by Payables Bidding System, the buyer, or both. As illustrated in block 313, embodiments may allow bidders bid only once in an instant or ongoing auction or submit one or multiple bids over a period of time in an ongoing auction environment.

In one embodiment, Payables Bidding System and/or Buyer accepts Jewelry Supplier's bid, as illustrated in block 314. As illustrated in block 315, Payables Bidding System notifies Supplier by email of an accepted discounted payment. Supplier's bid is thereafter optionally verified by System and/or human verification, as illustrated in block 316. Assuming the bid verifies, the Client is notified of the discounted amount it needs to send to Supplier, as illustrated in block 317. Buyer or Payables Bidding System thereafter forwards payment to Jewelry Supplier, as illustrated in block 318. The $100 from the discounted invoice ($5,000-$4,900) is then considered “savings” by the Buyer.

As illustrated in block 319, Payables Bidding System earns a $25 commission expressed as a 25% percentage of the Buyer's savings generated auction. It is understood that any commissions earned by Payables Bidding System is not herein limited to an exemplary $25 or 25%. Payables Bidding System then ends, as illustrated in block 320.

In another embodiment, Buyer rejects Jewelry Supplier's $4,900 bid via Payables Bidding System. The bidding process then ends without an agreed-upon discounted approved payment, as illustrated in block 320. Alternatively, as illustrated in block 321, Buyer can propose a counterbid or simply invite Supplier to submit another bid without providing a counter and/or providing Supplier feedback other than its prior rejection, as illustrated in block 326. As illustrated in block 322, Payables Bidding System informs Jewelry Supplier of Buyer's rejection of Jewelry Supplier's $4,900 bid and Buyer's counterbid of $4,800 in an email to Jewelry Supplier. The counterbid of $4,800 satisfies full payment of Jewelry Supplier's $5,000 invoice for bracelets. As illustrated in block 323, Jewelry Supplier may accept or reject Buyer's counterbid of $4,800 via a GUI in Payables Bidding System.

As illustrated in block 324, Payables Bidding System accepts Jewelry Supplier's $4,800 bid to fully satisfy the vouchered payable. As illustrated in block 315, Payables Bidding System notifies Buyer of an accepted discounted payment. As illustrated in block 316, such bid is verified by the system or via human interaction. As illustrated in block 317, Buyer is then notified of such mutually agreed upon discount. Buyer or Payables Bidding System thereafter forwards payment to Jewelry Supplier, as illustrated in block 318. If Supplier rejects the counterbid, as illustrated in block 325, the Supplier can bid again as illustrated in block 326. Supplier can then submit as many bids as permitted by system, as illustrated in block 327, where the bidding process can repeat continuously with Supplier submitting additional bids and counterbids, if the initial bids are rejected.

Payables Bidding System can retain records of the vouchered payments, transaction information, bidding record, and payment record between Buyer and Jewelry Supplier in a database for the previously described blocks 301 to 327. The retained information is used to improve future bidding negotiations between Buyer and Jewelry Supplier as well as to inform the Buyer for subsequent price negotiations with Supplier. Further, Buyer's transaction record retained in Payables Bidding System may be commercialized by Payables Bidding System.

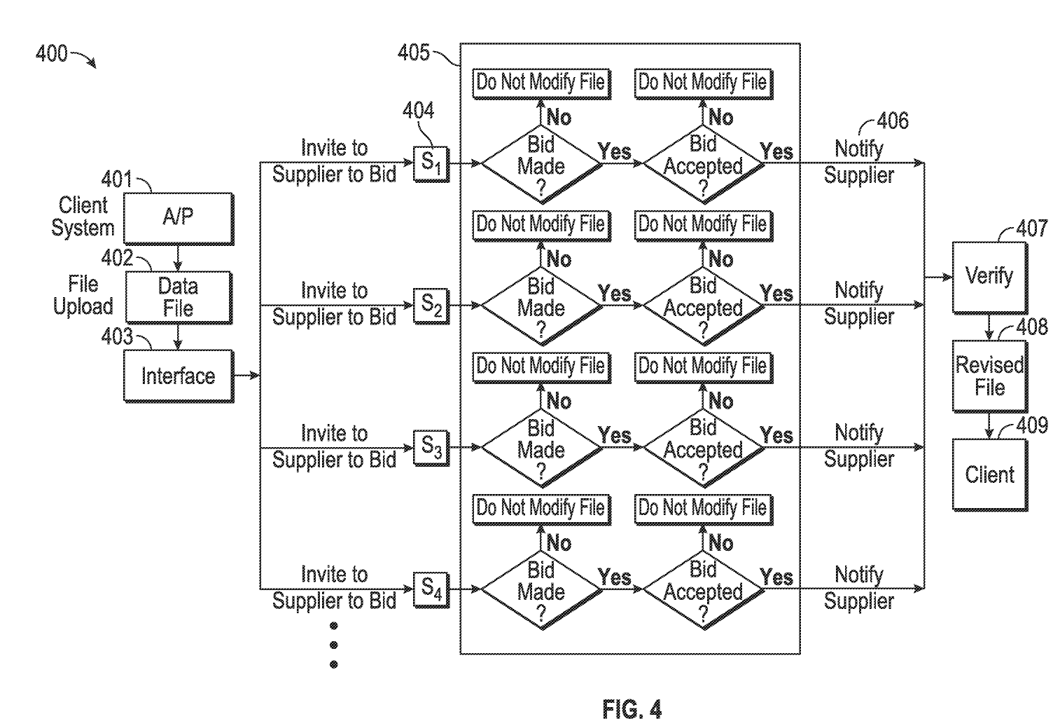

FIG. 4 illustrates an exemplary flow chart of operations 400 depicting logical operational steps of multiple bids in a payables bidding system, as disclosed in an embodiment. In client system 401, a data file is uploaded 402 containing vouchered payables information. On the payables bidding systems interface 403, suppliers 404 (S1 . . . S4) are invited to bid a discounted payment in at least one auction on buyer's vouchered payables. Suppliers submit a plurality bids 405 for acceptance. If at least one of the pluralities of bids 405 is accepted, then supplies is notified 406 regardless of an auction's outcome. Buyer's vouchered payable file is modified 407 with the discounted payment and client is notified 408.

The Payables Bidding System integrates with one or more Enterprise Resource software packages automatically modifying applicable invoices with appropriate discounts and scheduling them for a revised payment date. Certain Suppliers may also be excluded from utilizing the System. In other embodiments, Payables Bidding System promotes complimentary services to suppliers.

Various selectable options are provided for Client (i.e., Buyer) for the disclosed Payables Bidding System. In an alternative embodiment, System automatically selects a bid amount, confirms, and submits bid without user interaction based on pre-set bid options for the Supplier. A payable file is uploaded to the System or System automatically obtains payable information. When new user is identified by Payables Bidding System, user is sent an introductory, co-branded e-mail with welcome letter, info about program, instructions, and link to set up account. Master/slave accounts are established, where Master account has highest security clearance and may designate sub-accounts and restrict functionality by user level. Supplier may opt-out of receiving bid invitations in their “account settings.” Account set up can encompass terms and conditions that requires check box, and activation link in e-mail to finalize user set up. System can send user an automated confirmation e-mail when an account is set up.

Once a supplier account is set up, the System can send an invitation to bid e-mail in which suppliers are given notice to bid on payments if they desire prompt payment. The System displays available payments in body of e-mail. Supplier can click on link to access bidding screen. The System's Bidding screen displays invoice details and bidding options. Suppliers may bid on each payment separately or in any combination. Bid formats may be expressed as $ discount, % discount, $ net amount, or % of net amount, for example.

On the System's Confirm Bid Screen or Selection Option, the System generates pro-form a that displays the pro-form a payments (including gross payable, discounts bid, and net payments), expressed as $ discount, % discount, $ net amount, and % of net amount. The user can then choose to “Submit Bid as is” or “Edit Bid.” If Edit Bid is selected by user, the System returns to the previous Bid screen and allows user to change the bid amount. The user then confirms and submits that bid. The Submit Approved Bid Screen or selection option can contain a Disclaimer and Terms and Conditions with check box. User then views System's Confirmation Screen that informs the user if the user's bid was successfully submitted. System can inform user that System will contact user at the close of the auction with the auction results.

System provides various auction types that last various lengths of time. An auction can last less than one day, one day, or multiple days. A bidder is notified of acceptance or rejection at end of auction. In another embodiment, an auction can last less than one day, one day, or multiple days where user receives immediate and/or repeated feedback during auction, with further instruction and invitations to submit more bids. In an instant auction embodiment, user bids once and receives immediate notice of acceptance or rejection. User then waits a period of time before user can bid again. System displays real time auction stats including a moving line that may show bidders where their bids stand relative to others for bidding assistance.

After an auction closes, System sends an e-mail notification of bid acceptance or rejection with discussion of estimated payment date and further instruction. Based upon various circumstances, human verification of the successfully bid auction may be needed. Such verification can be included within System's verification queue. System creates a modified file and transfers to Buyer for action or automatic integration with buyer's payable systems. System can create an invoice representing % of discounts successfully accepted bids. Client or Payables Bidding System disburses net funds to successful bidders, as appropriate when the auction settles up.

Embodiments could include a model incorporating historical metrics to influence outcome of future bids. The System retains bid and acceptance data for and reporting module and for use in modeling, future dynamic bid acceptance, and algorithm. System also retains Supplier history/info, including but not limited to: prior minimum, max, median, average, and bid quartiles; prior acceptable/successful transaction percentage; bulk bid or single invoice bid; cancellation of previous transactions; proximity to last bid; feneral bidding trends and acceptance/rejection trends; buyer's relationship with supplier (quality of work, length of time servicing Buyer, number of invoices, average invoice size, Buyer's general business experience with Supplier); average and median invoice sizes of available payables; number of total payables available to be bid for a specific Buyer and for Payables Bidding System as a whole; time of day; time period between suppliers receipt and/or view of email and bid; quartile benchmarks, i.e., 25% of acceptable bids between an APR of 10-14%, 25% between 14%-16%, 25% between 16-17%, 25% in excess of 17%; random rejection regardless of bid value; the discounts which other bidders in an auction have bid; the amount of investment remaining in an auction; the amount of investment remaining in an auction relative to the total $ amount of payables potentially to be bid; the amount of investment remaining in an auction relative to the total number of payables potentially to be bid; the number of suppliers competing within an auction; the general success and/or demand of a specific auction; seasonality and/or proximity to holidays and/or proximity to banking holidays; day of the week; specific calendar days of the month, (i.e., proximity to pressure point days (1, 15, last day of month)); Buyer industry; Supplier industry; general credit options within the Supplier industry; general interest rates in the economy; geographic location of Buyer; geographic location of Supplier; general credit conditions in the city, state, or country of the Supplier; Supplier's concentration of business in Buyer; length of time Supplier has been in business; number of employees of Supplier; credit conditions of Supplier (D&B, etc.); credit conditions of Buyer.

System permits buyers to lengthen payment terms without adversely affecting under-funded suppliers that are unable to finance their accounts receivable through outside funding sources, or are adversely affected by having to wait an extended period of time for payment collection. System permits buyers to lengthen payment terms, thus increasing buyers' net working capital position. System creates a low-risk investment opportunity for the buyer, by allowing buyers to earn a return on available liquidity employed to prepay suppliers at a discount.

System maximizes discounts offered by suppliers, creating far greater savings in the aggregate for the buyer than traditionally negotiated prompt-payment discounts. System also maximizes discounts realized by the buyer through dynamic bid approval and rejection process in which suppliers bid against each other for a limited amount of available capital or dollars. System maintains buyers' gross profit margins and suppliers pricing of goods and services by dynamically altering the discount the buyer will accept through use of a customized algorithm. The algorithm inputs could include at least one of: Payables system yield comprising APR, % discount, and minimum $ discount; Buyer yield comprising APR, % discount, and minimum $ discount; and fee split between Buyer and Payables Bidding System.

Based on the foregoing, it can be appreciated that a number of advantages can result from implementation of the disclosed apparatus. A payables bidding system is disclosed. In one embodiment, the system comprises a processor; a data bus coupled to the processor; and a non-transitory computer readable storage device storing computer program code, the computer program code comprising program instructions executable by the processor. In an embodiment, the program instructions comprise: program instructions to engage a buyer having at least one vouchered payable for a good or a service; program instructions to facilitate discounting of the at least one vouchered payable of the buyer for the good or the service, wherein the good or the service is provided by a supplier; program instructions to solicit and submit at least one bid from the supplier via an auction process for the supplier to collect, prior to a due date of the at least one vouchered payable, on a discounted approved payment from the buyer on the vouchered payable; and program instructions to accept or reject the bid on the at least one vouchered payable.

In another embodiment, the payables bidding system further comprises program instructions to automatically detect and retain the at least one vouchered payable from the buyer by integrating with an account payables list of the buyer; and program instructions to obtain supplier information and information on the at least one vouchered payable. In other embodiments, the payables bidding system further comprises program instructions to automatically modify payment timing and payment amount of the at least one vouchered payable after accepting the bid, wherein the modified payment timing and payment amount are communicated to the buyer. In yet another embodiment, the payables bidding system further comprises program instructions to notify the supplier of the auction process with an option to bid a discount on the at least one vouchered payable for the buyer to receive payment of the at least one vouchered payable at the discounted rate and prior to the due date of the at least one vouchered payable.

In one embodiment, the payables bidding system further comprises program instructions to configure acceptable bid parameters for acceptance, rejection, delayed acceptance, delayed rejection, automatic acceptance, or automatic rejection of the bid on the at least one vouchered payable, wherein supplier bids once in the auction process or submits a plurality of bids in the auction process; program instructions to configure a plurality of inputs to accept or reject the at least one bid for a discount on the at least one vouchered payable; and program instructions to configure a plurality of inputs to accept or reject the at least one bid for a discount on the at least one vouchered payable, wherein the plurality of inputs comprises competition for finite available capital. In another embodiment, the payables bidding system further comprises program instructions to reject the bid on the at least one vouchered payable and proposing a counterbid to the supplier, wherein the supplier can accept or reject the counterbid, wherein the counterbid is based on pre-configured bidding parameters set by the buyer; and program instructions to reject the bid on the at least one vouchered payable and proposing a counterbid to the supplier, wherein the supplier accepts or rejects the counterbid, wherein the counterbid is based on pre-configured bidding parameters. In another embodiment, the payables bidding system further comprises program instructions to calculate a commission earned from the discounted vouchered payable after acceptance of the bid; and program instructions to retain at least one of: the at least one vouchered payable, a discounted vouchered payable amount, transaction information, bidding record, and payment record between the buyer and the supplier in a database to facilitate future bidding negotiations between the buyer and the supplier, future payables discount bids, and commercialization of retained data.

In yet another embodiment, a non-transitory computer-readable medium storing computer program code representing program instructions executable by a processor to cause a process for payables bidding is disclosed. In the embodiments, the program instructions comprise: program instructions to engage a buyer having at least one vouchered payable for a good or a service; program instructions to facilitate discounting of the at least one vouchered payable of the buyer for the good or the service, wherein the good or the service is provided by a supplier; program instructions to solicit and submit at least one bid from the supplier via an auction process for the supplier to collect, prior to a due date of the at least one vouchered payable, on a discounted approved payment from the buyer on the vouchered payable; and program instructions to accept or reject the bid on the at least one vouchered payable.

In one embodiment, the non-transitory computer-readable medium further comprises program instructions to automatically detect and retain the at least one vouchered payable from the buyer by integrating with an account payables list of the buyer; and program instructions to obtain supplier information and information on the at least one vouchered payable. In other embodiments, the non-transitory computer-readable medium further comprises program instructions to automatically modify payment timing and payment amount of the at least one vouchered payable after accepting the bid, wherein the modified payment timing and payment amount are communicated to the buyer. In yet another embodiment, the non-transitory computer-readable medium further comprises program instructions to notify the supplier of the auction process with an option to bid a discount on the at least one vouchered payable for the buyer to receive payment of the at least one vouchered payable at the discounted rate and prior to the due date of the at least one vouchered payable.

In an embodiment, the non-transitory computer-readable medium further comprises: program instructions to configure acceptable bid parameters for acceptance, rejection, delayed acceptance, delayed rejection, automatic acceptance, or automatic rejection of the bid on the at least one vouchered payable, wherein supplier bids once in the auction process or submits a plurality of bids in the auction process; program instructions to configure a plurality of inputs to accept or reject the at least one bid for a discount on the at least one vouchered payable; and program instructions to configure a plurality of inputs to accept or reject the at least one bid for a discount on the at least one vouchered payable, wherein the plurality of inputs comprises competition for finite available capital.

In other embodiments, the non-transitory computer-readable medium further comprises: program instructions to reject the bid on the at least one vouchered payable and propose a counterbid to the supplier, wherein the supplier can accept or reject the counterbid, wherein the counterbid is based on pre-configured bidding parameters set by the buyer; and program instructions to reject the bid on the at least one vouchered payable and proposing a counterbid to the supplier, wherein the supplier accepts or rejects the counterbid, wherein the counterbid is based on pre-configured bidding parameters. In another embodiment, the non-transitory computer-readable medium further comprises: program instructions to calculate a commission earned from the discounted vouchered payable after acceptance of the bid; and program instructions to retain at least one of: the at least one vouchered payable, a discounted vouchered payable amount, transaction information, bidding record, and payment record between the buyer and the supplier in a database to facilitate future bidding negotiations between the buyer and the supplier, future payables discount bids, and commercialization of retained data.

In an embodiment, a computer-implemented payables bidding method is disclosed. The method comprises: a computer engaging a buyer having at least one vouchered payable for a good or a service; the computer facilitating discounting of the at least one vouchered payable of the buyer for the good or the service, wherein the good or the service is provided by a supplier; the computer soliciting and submitting at least one bid from the supplier via an auction process for the supplier to collect, prior to a due date of the at least one vouchered payable, on a discounted approved payment from the buyer on the vouchered payable; and the computer accepting or rejecting the bid on the at least one vouchered payable.

In another embodiment, the computer-implemented payables bidding method further comprises: the computer automatically detecting and retaining the at least one vouchered payable from the buyer by integrating with an account payables list of the buyer; and the computer obtaining supplier information and information on the at least one vouchered payable. In yet other embodiments, the computer-implemented payables bidding method further comprises the computer notifying the supplier of the auction process with an option to bid a discount on the at least one vouchered payable for the buyer to receive payment of the at least one vouchered payable at the discounted rate and prior to the due date of the at least one vouchered payable.

In an embodiment, the computer-implemented payables bidding method further comprises: the computer configuring acceptable bid parameters for acceptance, rejection, delayed acceptance, delayed rejection, automatic acceptance, or automatic rejection of the bid on the at least one vouchered payable, wherein supplier bids once in the auction process or submits a plurality of bids in the auction process; the computer configuring a plurality of inputs to accept or reject the at least one bid for a discount on the at least one vouchered payable; and the computer configuring a plurality of inputs to accept or reject the at least one bid for a discount on the at least one vouchered payable, wherein the plurality of inputs comprises competition for finite available capital. In other embodiments, the computer-implemented payables bidding method further comprises: the computer rejecting the bid on the at least one vouchered payable and proposing a counterbid to the supplier, wherein the supplier can accept or reject the counterbid, wherein the counterbid is based on pre-configured bidding parameters set by the buyer; and the computer automatically modifying payment timing and payment amount of the at least one vouchered payable after accepting the bid, wherein the modified payment timing and payment amount are communicated to the buyer. In another embodiment, the computer-implemented payables bidding method further comprises: the computer calculating a commission earned from the discounted vouchered payable after acceptance of the bid; the computer retaining at least one of: the at least one vouchered payable, a discounted vouchered payable amount, transaction information, bidding record, and payment record between the buyer and the supplier in a database to facilitate future bidding negotiations between the buyer and the supplier, future payables discount bids, and commercialization of retained data.

It will be appreciated that variations of the above-disclosed and other features and functions, or alternatives thereof, may be desirably combined into many other different systems or applications. Furthermore, various presently unforeseen or unanticipated alternatives, modifications, variations or improvements therein may be subsequently made by those skilled in the art, which are also intended to be encompassed by the following claims.

What is claimed is:

1. A payables bidding system, comprising:
a processor;
a data bus coupled to said processor; and
a non-transitory computer readable storage device storing computer program code, said computer program code comprising program instructions executable by said processor, said program instructions comprising to:
engage a buyer having at least one vouchered payable for a good or a service;
facilitate discounting of said at least one vouchered payable of said buyer for said good or said service, wherein said good or said service is provided by a supplier;
solicit and submit at least one bid from said supplier via an auction process for said supplier to collect, prior to a due date of said at least one vouchered payable, on a discounted approved payment from said buyer on said vouchered payable; and
accept or reject said bid on said at least one vouchered payable.

2. The payables bidding system of claim 1 further comprising:
program instructions to automatically detect and retain said at least one vouchered payable from said buyer by integrating with an account payables list of said buyer; and
program instructions to obtain supplier information and information on said at least one vouchered payable.

3. The payables bidding system of claim 1 further comprising program instructions to automatically modify payment timing and payment amount of said at least one vouchered payable after accepting said bid, wherein said modified payment timing and payment amount are communicated to said buyer.

4. The payables bidding system of claim 1 further comprising program instructions to notify said supplier of said auction process with an option to bid a discount on said at least one vouchered payable for said buyer to receive payment of said at least one vouchered payable at said discounted rate and prior to said due date of said at least one vouchered payable.

5. The payables bidding system of claim 1 further comprising:
program instructions to configure acceptable bid parameters for acceptance, rejection, delayed acceptance, delayed rejection, automatic acceptance, or automatic rejection of said bid on said at least one vouchered payable, wherein supplier bids once in said auction process or submits a plurality of bids in said auction process;
program instructions to configure a plurality of inputs to accept or reject said at least one bid for a discount on said at least one vouchered payable; and
program instructions to configure a plurality of inputs to accept or reject said at least one bid for a discount on said at least one vouchered payable, wherein said plurality of inputs comprises competition for finite available capital.

6. The payables bidding system of claim 1 further comprising:
program instructions to reject said bid on said at least one vouchered payable and propose a counterbid to said supplier, wherein said supplier can accept or reject said counterbid, wherein said counterbid is based on pre-configured bidding parameters set by said buyer; and
program instructions to reject said bid on said at least one vouchered payable and propose a counterbid to said supplier, wherein said supplier accepts or rejects said counterbid, wherein said counterbid is based on pre-configured bidding parameters.

7. The payables bidding system of claim 1 further comprising:
program instructions to calculate a commission earned from said discounted vouchered payable after acceptance of said bid; and
program instructions to retain at least one of: said at least one vouchered payable, a discounted vouchered payable amount, transaction information, bidding record, and payment record between said buyer and said supplier in a database to facilitate future bidding negotiations between said buyer and said supplier, future payables discount bids, and commercialization of retained data.

8. A non-transitory computer-readable medium storing computer program code representing program instructions executable by a processor to cause a process for payables bidding, said program instructions comprising to:
engage a buyer having at least one vouchered payable for a good or a service;
facilitate discounting of said at least one vouchered payable of said buyer for said good or said service; wherein said good or said service is provided by a supplier;
solicit and submit at least one bid from said supplier via an auction process for said supplier to collect, prior to a due date of said at least one vouchered payable, on a discounted approved payment from said buyer on said vouchered payable; and
accept or reject said bid on said at least one vouchered payable.

9. The non-transitory computer-readable medium of claim 8 further comprising:
program instructions to automatically detect and retain said at least one vouchered payable from said buyer by integrating with an account payables list of said buyer; and
program instructions to obtain supplier information and information on said at least one vouchered payable.

10. The non-transitory computer-readable medium of claim 8 further comprising program instructions to automatically modify payment timing and payment amount of said at least one vouchered payable after accepting said bid, wherein said modified payment timing and payment amount are communicated to said buyer.

11. The non-transitory computer-readable medium of claim 8 further comprising program instructions to notify said supplier of said auction process with an option to bid a discount on said at least one vouchered payable for said buyer to receive payment of said at least one vouchered payable at said discounted rate and prior to said due date of said at least one vouchered payable.

12. The non-transitory computer-readable medium of claim 8 further comprising:
program instructions to configure acceptable bid parameters for acceptance, rejection, delayed acceptance, delayed rejection, automatic acceptance, or automatic rejection of said bid on said at least one vouchered payable, wherein supplier bids once in said auction process or submits a plurality of bids in said auction process;
program instructions to configure a plurality of inputs to accept or reject said at least one bid for a discount on said at least one vouchered payable; and
program instructions to configure a plurality of inputs to accept or reject said at least one bid for a discount on said at least one vouchered payable, wherein said plurality of inputs comprises competition for finite available capital.

13. The non-transitory computer-readable medium of claim 8 further comprising:
program instructions to reject said bid on said at least one vouchered payable and propose a counterbid to said supplier, wherein said supplier can accept or reject said counterbid, wherein said counterbid is based on pre-configured bidding parameters set by said buyer; and
program instructions to reject said bid on said at least one vouchered payable and propose a counterbid to said supplier, wherein said supplier accepts or rejects said counterbid, wherein said counterbid is based on pre-configured bidding parameters.

14. The non-transitory computer-readable medium of claim 8 further comprising:
program instructions to calculate a commission earned from said discounted vouchered payable after acceptance of said bid; and
program instructions to retain at least one of: said at least one vouchered payable, a discounted vouchered payable amount, transaction information, bidding record, and payment record between said buyer and said supplier in a database to facilitate future bidding negotiations between said buyer and said supplier, future payables discount bids, and commercialization of retained data.

15. A computer-implemented payables bidding method, comprising:
a computer engaging a buyer having at least one vouchered payable for a good or a service;
said computer facilitating discounting of said at least one vouchered payable of said buyer for said good or said service, wherein said good or said service is provided by a supplier;
said computer soliciting and submitting at least one bid from said supplier via an auction process for said supplier to collect, prior to a due date of said at least one vouchered payable, on a discounted approved payment from said buyer on said vouchered payable; and
said computer accepting or rejecting said bid on said at least one vouchered payable.

16. The computer-implemented payables bidding method of claim 15 further comprising:
said computer automatically detecting and retaining said at least one vouchered payable from said buyer by integrating with an account payables list of said buyer; and
said computer obtaining supplier information and information on said at least one vouchered payable.

17. The computer-implemented payables bidding method of claim 15 further comprising said computer notifying said supplier of said auction process with an option to bid a discount on said at least one vouchered payable for said buyer to receive payment of said at least one vouchered payable at said discounted rate and prior to said due date of said at least one vouchered payable.

18. The computer-implemented payables bidding method of claim 15 further comprising:
said computer configuring acceptable bid parameters for acceptance, rejection, delayed acceptance, delayed rejection, automatic acceptance, or automatic rejection of said bid on said at least one vouchered payable, wherein supplier bids once in said auction process or submits a plurality of bids in said auction process;
said computer configuring a plurality of inputs to accept or reject said at least one bid for a discount on said at least one vouchered payable; and
said computer configuring a plurality of inputs to accept or reject said at least one bid for a discount on said at least one vouchered payable, wherein said plurality of inputs comprises competition for finite available capital.

19. The computer-implemented payables bidding method of claim 15 further comprising:
said computer rejecting said bid on said at least one vouchered payable and proposing a counterbid to said supplier, wherein said supplier can accept or reject said counterbid, wherein said counterbid is based on pre-configured bidding parameters set by said buyer; and
said computer automatically modifying payment timing and payment amount of said at least one vouchered payable after accepting said bid, wherein said modified payment timing and payment amount are communicated to said buyer.

20. The computer-implemented payables bidding method of claim 15 further comprising:
said computer calculating a commission earned from said discounted vouchered payable after acceptance of said bid; and
said computer retaining at least one of: said at least one vouchered payable, a discounted vouchered payable amount, transaction information, bidding record, and payment record between said buyer and said supplier in a database to facilitate future bidding negotiations between said buyer and said supplier, future payables discount bids, and commercialization of retained data.
